(19) United States
(12) Patent Application Publication
(10) Pub. No.: US 2003/0185151 A1
(43) Pub. Date: Oct. 2, 2003

(54) Information processing system and information terminal thereof having a route switching function

(75) Inventors: Ryuji Kurosawa, Kawasaki (JP); Yasuhira Kushida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/269,071

(22) Filed: Oct. 11, 2002

(30) Foreign Application Priority Data
Mar. 27, 2002 (JP) 2002-088833

(51) Int. Cl. G01R 31/08

(52) U.S. Cl. 370/219; 370/220

(57) ABSTRACT

An information processing system and an information terminal thereof and, in particular, an information processing system and an information terminal thereof are provided in which business work can be continuously performed via an external network, such as the Internet, by co-operating with a high-ranking host computer even during a failure. In an information processing system in which the information terminal communicates with the information processor in an external IP network via a main circuit for normal use or a secondary circuit for use when a failure occurs, provided with the router, the information terminal has a communication failure detecting means to detect a communication failure at an application level during communication with the information processor, and route switching instruction means to instruct to the router to switch from a main circuit to a secondary circuit by detecting the communication failure. The router has a route switching means to switch from a communication route between the information terminal and the information processor via the main circuit to a communication route via the secondary circuit, by the route switching instruction, due to the failure.

### BACKGROUND OF THE INVENTION

1. Field of the Invention

The present invention relates to an information processing system and an information terminal thereof. Particularly, the present invention relates to an information processing system and an information terminal thereof in which a POS (Point Of Sales) terminal executes given work by cooperating with a host computer via an external network, such as the internet, in a POS system.

2. Description of the Related Art

In a conventional POS system, a plurality of POS terminals in a store are connected to a business computer in the store by a cable or wirelessly, or, POS terminals in plural franchise are connected to a host computer in a data center via a dedicated line, or a telephone line, or the like.

Along with a recent widespread availability of Internet access, a new type of POS system has appeared in which stores of various lines of business kind access a host computer of a contractor specialized in business management via the internet, to perform product sales management or inventory management for each store.

The network accessing method has become variable. A low-cost service for full-time connection to the internet, such as an ADSL (Asymmetric Digital Subscriber Line) service or an ISDN service (for example, Flets IDSN (registered trademark)), is available and, consequently, utilization environment of new POS system mentioned above is being built.

By the way, in the above-mentioned POS system, important data regarding product sales or inventories for each store is transmitted through the internet. Thus, a problem avoidance/recovery means is required for protection of the data during transmission, or in the event of a communication failure.

In particular, when communication fails, a session between a POS terminal application of a store side and a host application of a service contractor side can be disconnected by a construction of a network side, resulting in an offline state of the POS terminal, and an operation thereof is suddenly stopped. In the POS system, an interruption of business cannot be permitted and, thus, a means to quickly react to such a failure has been required.

A communication failure occurring between applications cannot be avoided only by detecting a hardware problem such as conventional line disconnection or corruption of a communication device. A data problem can occur on only one channel (for example, a B1 or a B2 channel of ISDN) of a logical channel assigned to each POS terminal, and such a case cannot detected by a hardware either.

In the case of connection to the internet via one router to which a plurality of POS terminals in a store are connected, when the router suddenly switched to a spare line shortly after detecting a hardware corruption, such as a line disconnection, between the router and the internet, important data such as a session statement or a statement half-way through trading on the application on each POS terminal can be lost. Recovery of the data or a data identification can be difficult.

### SUMMARY OF THE INVENTION

The object of the present invention is to provide an information processing system and an information terminal thereof, in which an information terminal such as a POS terminal is permenantly connected to a host computer of a network side via a router wherein, when a client application of an information terminal side detects a communication failure to the host computer, the router switches the communication route from a main circuit to a reserved spare circuit due to an instruction from the information terminal side.

The object of the present invention is also to provide an information processing system, and an information terminal thereof, in which the router automatically returns to the communication route using the main circuit due to an instruction from the information terminal side when the client application of the information terminal side has confirmed a communication recovery between the host computer after the communication route is switched to the secondary circuit.

As mentioned above, if a communication failure can be detected on an application level of the information terminal side, the communication between the host computer can continue and the information terminal operation does not stop even after not only a hardware problem such as a line disconnection but also a software problem has occurred. The automatic recovery is carried out in a short time to the main circuit which is generally more advantageous for a line speed or cost than the secondary circuit and, therefore, the cost of the problems can be kept minimum. An interrupting process for a session statement or sending/receiving data becomes possible on the information terminal side before the circuit is switched, therefore a loss of important data, involved in the route switching, can be prevented.

According to the present invention, there provided an information processing system in which an information terminal communicates with an information processor, in an external IP network, via a main circuit for normal use, or a secondary circuit for use when a failure occurs, each of which is provided with a router, wherein

the information terminal comprises a communication failure detecting means for detecting a communication failure at an application level during communication with the information processor and a route switching instruction means for instructing the router to switch from a main circuit to a secondary circuit in accordance with the detection of the communication failure,

said router comprising a route switching means to switch a communication route, between the information terminal and the information processor, from the main circuit to a communication route via the secondary circuit, in accordance with the route switching instructions issued due to the failure.

Each of the main circuit and the secondary circuit have a different IP address. An external IP network through which the main circuit passes is different from the network the secondary circuit passes through. The main circuit is a usual connecting line, and the secondary circuit is used only during a failure.

According to the present invention, an information system which communicates with an information processor in an external IP network via a main circuit during operation or a secondary circuit during communication failure which are provided with the router, in which the information terminal has a communication failure detecting means to detect a communication failure at an application level during a communication with the information processor and a route switching instruction means to instruct to the router to switch the circuit from the main circuit to the secondary circuit based on detecting the communication failure. The communication failure is a disconnection of a transmitting session between the client application of the information terminal and the server application of the information processor.

The router has a receiving means for receiving route switching instructions based on a communication failure at an application level, supplied from the information terminal, and a route switching means for switching the communication route between the information terminal and the information processor from the main circuit to a route via the secondary circuit.

### BRIEF DESCRIPTION OF THE DRAWINGS

The present invention will be more clearly understood from the description as set forth below with reference to the accompanying drawings.

FIG. 1 shows a basic structure of an information processing system according to the present invention.

FIG. 2 shows an example of a route switching operation according to the present invention.

FIG. 3 is a concrete example of a POS system according to the present invention.

FIG. 4 is a first embodiment of the present invention.

FIG. 5 is a flowchart of control of a POS terminal in FIG. 4.

FIG. 6 is a sequential example of an entire POS system in FIG. 4.

FIG. 7 is a second embodiment of the present invention.

FIG. 8 is a flowchart of control of a POS terminal in FIG. 7.

FIG. 9 is a sequential example of an entire POS system in FIG. 7.

### DESCRIPTION OF THE PREFERRED EMBODIMENT

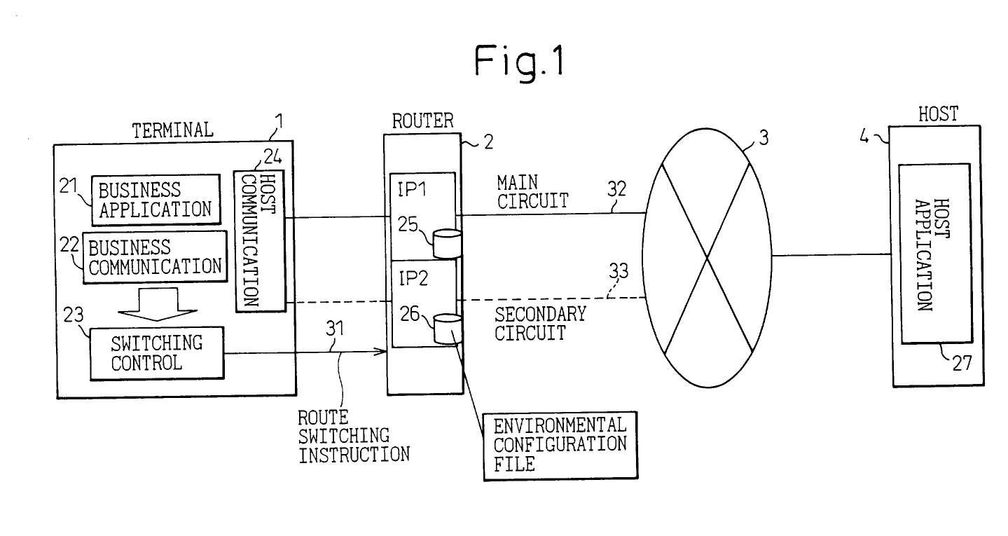

FIG. 1 is an example showing a basic structure of an information processing system according to the present invention.

In FIG. 1, an information terminal 1 is connected to a router 2, the router 2 is connected to a network 3 via a main circuit 32 which is a usual connecting line. When a problem occurred, the router 2 is connected to the network 3 via a secondary circuit which is a dial-up connection line. A host computer 4 which provides various business services in an information processing system is connected to the network 3.

when an ADSL or Flets IDSN service is used as the main circuit 32, the router 2 uses a dial-up connection for the first connection to the network 3. The network 3 contains various networks such as the internet, public-switched telephone network, wireless communication network, in-house LAN, and high speed IP network of a common carrier (WAN).

A client/server relationship is structured between a business application part 21 of the information terminal 1 and a host application part 27 of the host computer 4, in which the business application is a client and the host application is a server. The host application part 27 is comprised of various software for information processing, an HTTP server and a database liaising therewith or the like. A business communication part 22 sends or receives mainly business data between the host application part 27, and executes an HTTP client function (a web browser function) which displays the received data. An host communication part 24 communicates with the host computer 4 via the network 3 using TCP/IP protocol.

A switching control part 22 controls the router 2 by telnet to remotely control a resetting, a route switching instruction 31, a dial-up connection and such, and ICMP (Internet Control Message Protocol) to check the normality of a communication route using a Ping command. The switching control part 22 executes a function to obtain an IP address using DHCP (Dynamic Host Configuration Protocol) function of the router 2 when accessed to the router 2 or the like.

The router 2 has two IP addresses, IP1 for the main circuit and IP2 for the secondary circuit, and accesses the host computer 4 via a predetermined network using an environment configuration files 25 and 26 of IP1 and IP2. In the environment configuration files 25 and 26, a telephone number of an access point which is necessary for a dial-up connection, a user ID and a password other than the IP address (or a host name) are set. When a failure has occurred, the router switches between the main circuit 32 and the secondary circuit 33 due to the route switching instruction 31 from the switching instruction part 23 of the information terminal 1.

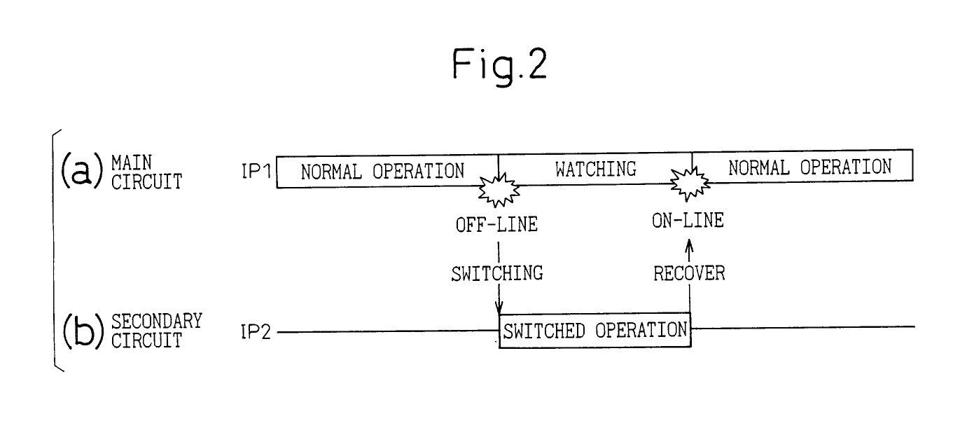

FIG. 2 shows an example of an route switching operation of the router 2 according to the present invention.

As shown in (a) of FIG. 2, the information terminal 1 is normally full-time connected to the main circuit 32. The business communication part 22 of the information terminal 1 establishes a session between the host computer 4 via a network using IP1 address. When a failure occurs in the network 3 side, the session is disconnected. This off-line state is detected by the business communication part 22, and the business communication part 22 instructs the switching control part 23 switch the circuit.

Thus, the switching control part 23 gives the router 2, which is connected to a LAN, the route switching instruction 31 using a TELNET command. The router 2 switches the circuit to the secondary circuit 33 as shown in (2) of FIG. 2, due to the route switching instruction from the information terminal 1. Then, the router 2 executes dial-up connection to an access point to which the secondary circuit 33 is connected using information of the environment configuration file 26. After that, a communication between the host computer 4 via another network using IP2 address continues.

The business communication part 22 regularly sends a Ping command to the main circuit 32 side which is fulltime connected even during in connection with the secondary circuit 33, and monitors a recovery of the main circuit 32. When the recovery is detected, it is reported to the route switching control part 23. The route switching control part 23 instructs the router 2 to return to the main circuit side by a TELNET command, and the router 2 switches the line to the main circuit 32. Thus, communication via a network using the IP1 of the main circuit side can be restarted.

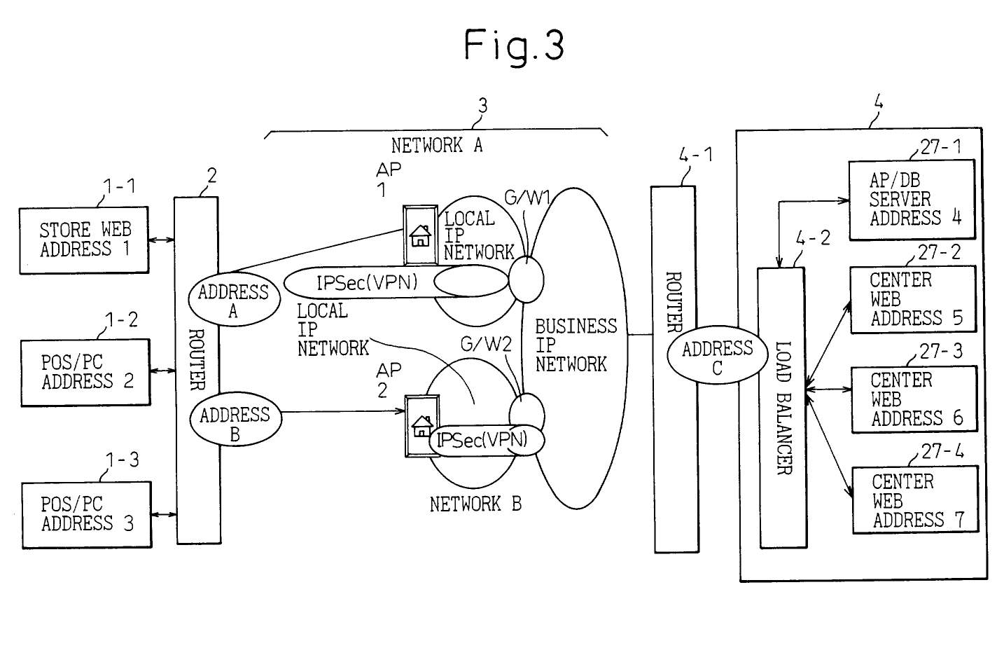

FIG. 3 shows an example of a POS system structure as a more concrete example of the above-mentioned present invention. A basic structure and the operation of the present invention is as mentioned above. A concrete structural part will be explained below.

In FIG. 3, a store web server 1-1 and POS/PC terminals 1-2, 1-3 are each based on a personal computer (PC) and each correspond to the information terminal 1 of FIG. 1. The store web server 1 works as the HTTP server/client, and the POS/PC terminal 1-2, 1-3 work as an HTTP client and as a browser for the POS. The store web server 1-1 processes a predetermined POS business in-house based on a data from the POS/PC terminals 1-2 and 1-3. The processed data is sent or received between the host computer 4 via a network 3. The POS/PC terminals 12 and 1-3 send or receive data such as product sales between the store web server 1, or send or receive the data between the host computer 4 via the network 3 directly.

The router 2 assigns each private IP address (address 1-3) to the store web server 1 and POS/PC terminals 1-2, 1-3 using its DHCP function when the store web server 1 and POS/PC terminals 1-2, 1-3 are connected to the router 2 on a LAN. Each IP address is translated to a global IP address using a NAT (Network Address Translator) function, so that communications between the store web server 1, POS/PC terminals 1-2, 1-3 and the host computer 4 is available.

The router 2 reserves two IP addresses, an address A and an address B. The address A is used for a connection via a local IP network (Network A) of an access point 1 (AP1) as the main circuit, and the address B is used for a connection via a local IP network (Network B) of an access point 2 (AP2) as the secondary circuit.

This local IP network, for example, corresponds to an IP network in a predetermined domain under an ISP (Internet Service Provider) or an in-house network. In this embodiment, a VPN (Virtual Private Network) is used to ensure security of POS data. The local IP network is connected to a business IP network of a high speed backbone which is build with ATM (Asynchronous Transfer mode) or WDM (Wavelength Division Multiplexing) via a gateway (G/W).

The host computer 4 is connected to the business IP network via a router 4-1. The host computer 4 is structured by an application/database server 27-1 which corresponds to the host application part 27 of FIG. 1 and a plurality of center web servers 27-2˜27-4.

The application/database server 27-1 processes various POS business using a database co-operating with each center web server 27-2˜27-4. The center web servers 27-2˜27-4 are independent HTTP servers. A load balancer 4-2 distributes the load of the each center web server 27-2˜27-4.

In this embodiment, the router 4-1 assigns private IP addresses (address 4˜7) to each server by DHCP function, and translates each IP address into a global IP address by a NAT function. Thus, the each server 27-1˜27-4 can communicate with each store web server 1-1 and POS/PC terminals 1-2, 1-3 via the network 3. Server daemon programs 27-1˜27-4 to which port numbers are properly assigned can be operated on one host computer.

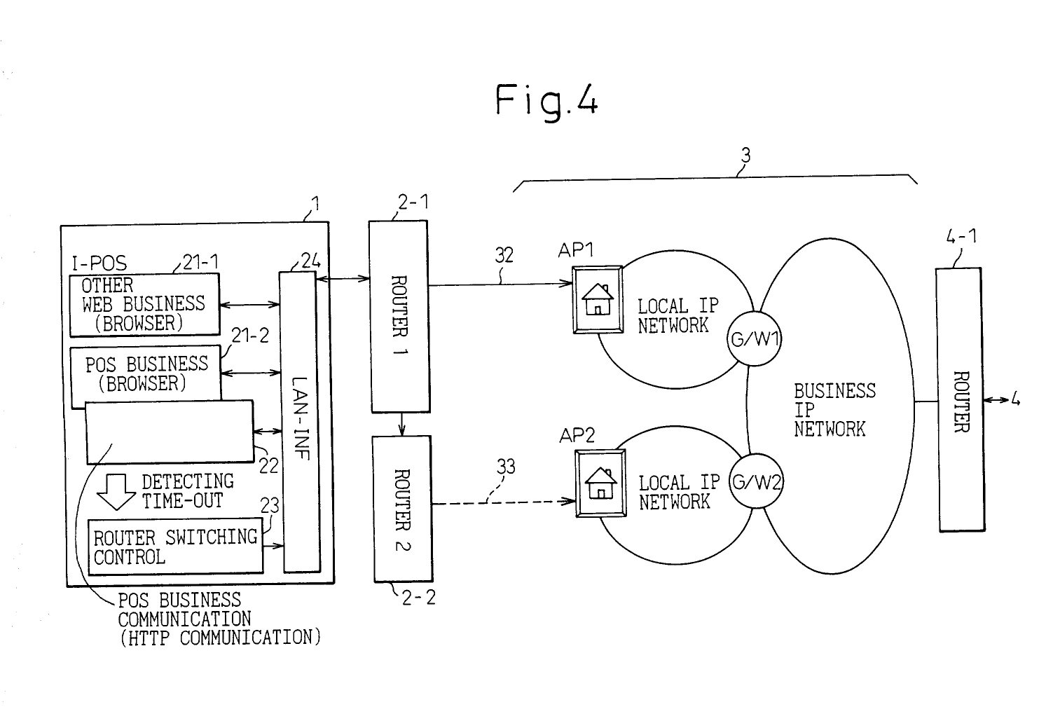

FIGS. 4-6 show a first embodiment of the present invention.

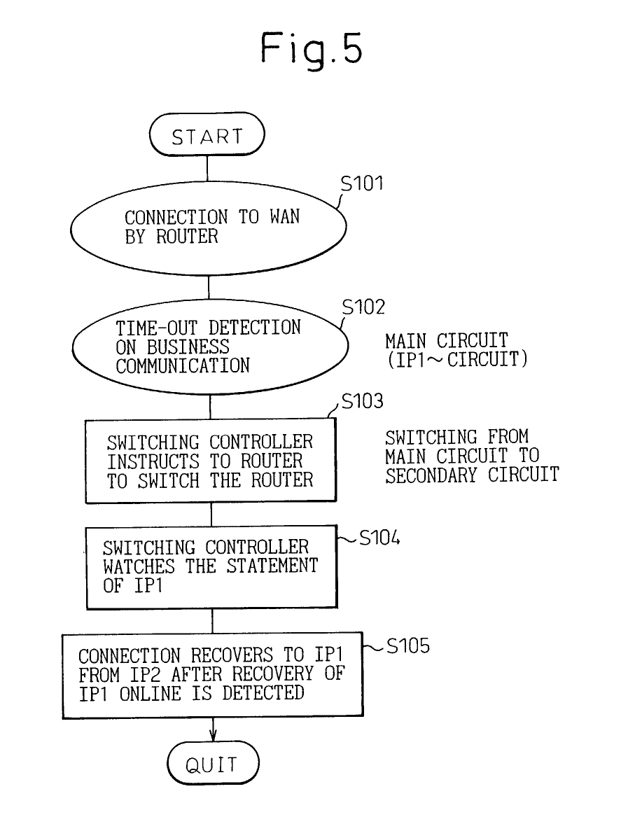

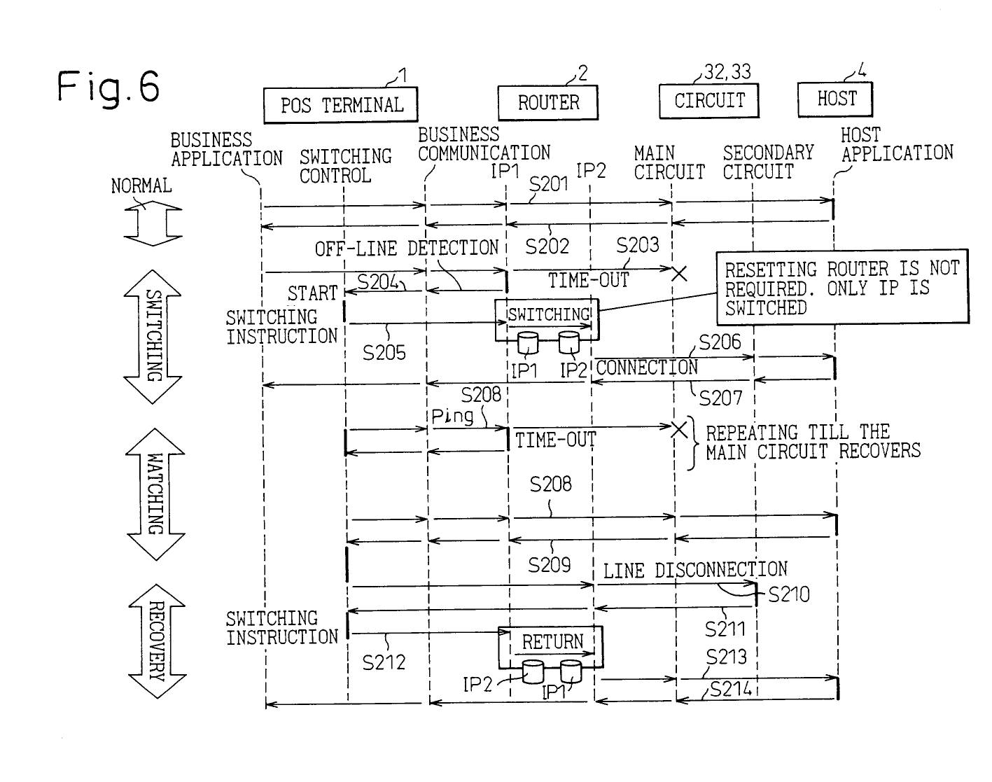

Two routers are used and each has a different IP address in this embodiment. FIG. 4 shows the concrete structural example, FIG. 5 shows a control flow of the POS terminal, and FIG. 6 shows an example of a control sequence of entire POS system.

In FIG. 4, the POS terminal 1 is connected to a router 2-1 for the main circuit 32 and further connected to a router 2-2 for the secondary circuit 33 therethrough. In the POS terminal 1, the other web business part 21-1 and POS business part 21-2 correspond to the business application part 21 of FIG. 1. The web business part 21-1 is comprised of a ordinary browsing software and the POS business part 21-2 is comprised of a browsing software especially for the POS. These software is downloaded from the host computer 4 on startup of the POS terminal 1.

The POS business communication part 22 corresponds to the business communication part of FIG. 1 and executes HTTP communication between each center web server 272-2˜7-4 (FIG. 3) of the host computer 4. A LAN-INF part 24 corresponds to the host communication part of FIG. 1, and executes a TCP/IP communication process as well as a LAN interface such as Ethernet (Registered Trademark).

This embodiment will be explained below as an operation of the POS terminal 1. As shown in FIG. 5, first the POS terminal 1 is connected to the router 2-1 which is for the main circuit, obtains a private IP address and downloads the browsing software (s101). Next, the POS business communication part 22 starts sending or receiving data based on HTTP between the other web business part 21-1 and POS business part 21-2, and center web servers 27-2˜27-4 of the host computer. The POS business part 22 watches for a release or disconnection of HTTP session. If these states continue for more than a predetermined time, the POS business part 22 detects a timeout (S102) that is notified to the router switching controller 23.

The router switching controller 23 instructs the router 2-1 to switch the route by TELNET command. After the route is switched to the secondary circuit via the router 2-2, the router switching controller 23 regularly sends a Ping command to the main circuit via the router 2-1 to watch for a recovery of the main circuit (S103 and S104). When the router switching controller 23 receives a Ping command which is sent by the router switching controller 23, it determines that the main circuit has recovered, and instructs to the router 2-1 by TELNET command to return to the main circuit (S105).

The above will be explained below as the operation of the entire POS system. As shown in FIG. 6, HTTP session is established between a browser of the POS terminal 1 and the center web servers 27-2˜27-4 of the host computer on a normal operation (S201 and S202). When a problem has occurred on the main circuit side (shown as x mark), the POS business communication part 22 of the POS terminal 1 detects timeout after the session is disconnected for a predetermined time. That is noticed by the router switching controller 23 (S204).

The router switching controller 23 instructs the router 2-1 to switch the route by a TELNET command (S205). The router 2-1 switches the communication route to an alternative route of the secondary circuit via the router 2-2. After that, the HTTP session between a browser of the POS terminal 1 and the center web servers 27-2˜27-4 of the host computer via the secondary circuit 33 recovers and the communication continues (S206 and S207).

During the problem time, the router switching controller 23 regularly sends Ping command to the host computer 4 through the main circuit 32 of the router 2-1 to watch for a recovery of the network of the main circuit (S208). The router switching controller 23 determines that the problem is recovered (S208 and S209) if the Ping command succeeds, and instructs the router 2-1 to switch the route to the main circuit by TELNET command (S210˜S212).

After that, the HTTP session between a browser of the POS terminal 1 and the center web servers 27-2˜27-4 of the host computer via the main circuit 33 recovers and the communication continues (S213 and S214).

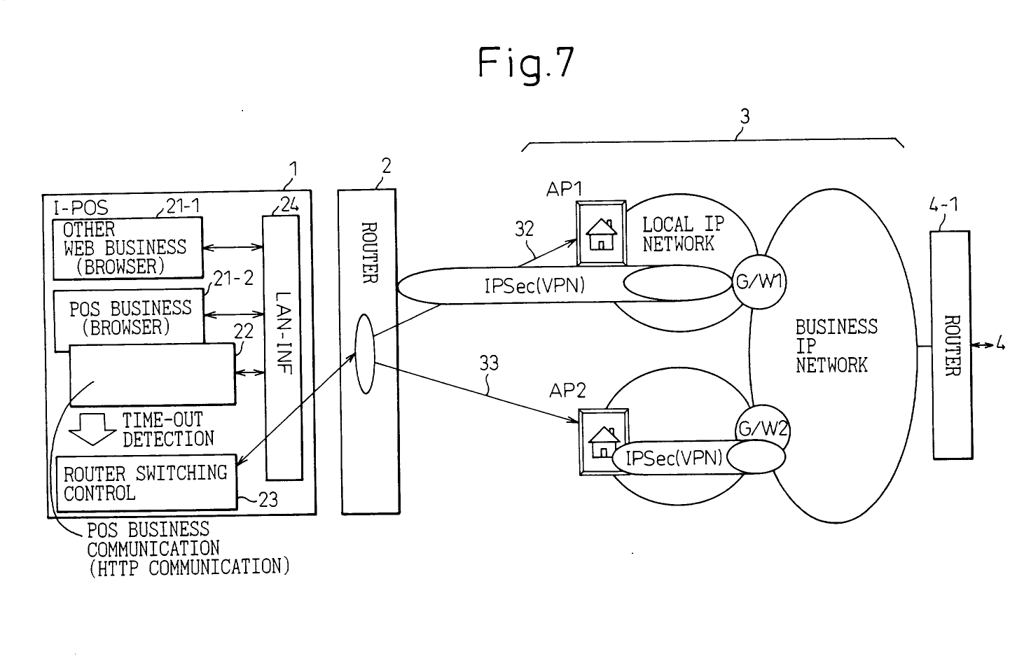

FIGS. 7-9 show a second embodiment of the present invention.

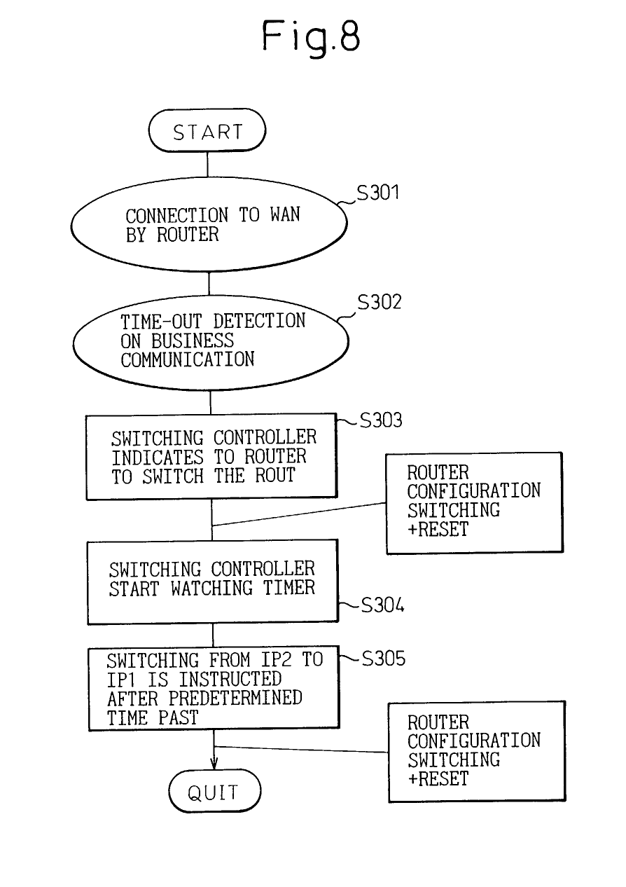

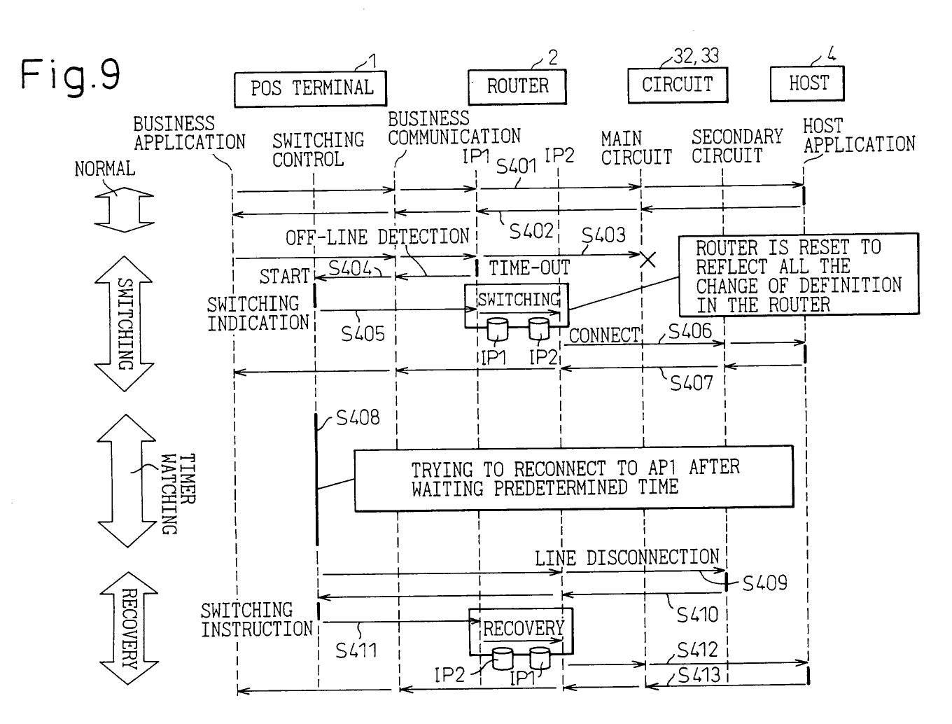

In this embodiment, one router is used and has one IP address. FIG. 7 shows the concrete structural example, FIG. 8 shows a control flow of the POS terminal, and FIG. 9 shows an example of a control sequence of entire POS system.

In FIG. 7, the POS terminal 1 carries out dial-up connection to an access point 1 (AP1) of the main circuit 32 side via the router 2 under normal circumstances. As shown in FIG. 8, operation steps S301˜S303 of the POS terminal 1 are the same as those of steps S101˜1103 of FIG. 5.

When the router 2 of this embodiment receives an instruction to switch the route (S303), an access point configuration is changed from the access point to another access point 2 (AP2). Consequently, the environment configuration file 26 of the router 2 (FIG. 1) is set to be used. After that, the router 2 resets itself to change the definition contents of the router, and executes dial-up connection using PPP (Point to Point Protocol) after being re-activated. Consequently, the router 2 obtains an IP address which is required for communication.

Next, the router switching controller 23 starts a timer after the instruction of route switching (S304). The timer instructs the router 2 to switch the route of the main circuit by TELNET command at intervals of, for example, 10 to 20 minutes (S305) at which the set time of the timer expires.

As mentioned above, when the router 2 receives an instruction to switch the route to the main circuit side, the utility of the environment configuration file 25 (FIG. 1) of the access point 1 is set, and it accesses the access point 1 by a PPP dial-up connection after being reactivated. If the problem is resolved, the router switches to the main circuit side, and a normal operation state will be restored. If the problem is not resolved, operations after step 302 will be repeated.

FIG. 9 shows an entire operation of the POS system in this embodiment. In FIG. 9, steps S401˜S407 are the same as steps S201˜S207 in FIG. 6 in principle.

The router switching controller 23 starts the timer after instruction of the route switching (S408). When the set time of the timer lapses, the router switching controller 23 instructs to the router 2 to switch to the main circuit side by TELNET command (S409˜S411) to try to return to the main circuit side. If the problem is resolved, the router switches to the main circuit side (S412 and S413), and a normal operation state will be restored.

As explained above, according to the present invention, a communication failure is detected at an application level of the information terminal side, and the information terminal side switches from the main circuit on which the communication failure is occurred to a secondary circuit. A hardware problem such as a line disconnection is included in the communication failure, and detection of a data problem of a particular channel is also included. As a result, communication to the host computer can be continued after a hardware or software problem occurs, that is, the communication between the information processing system via a network cannot be interrupted.

According to the present invention, if a public dial-up line is used as a secondary circuit, a special facility is not required for the secondary circuit. Moreover, the cost of a problem can be kept small because of the quick recovery to the main circuit which is generally advantageous to the secondary circuit at the point of line speed or a cost.

Furthermore, according to the present invention, an application of the information terminal controls the route switching, therefore, data such as a session statement or a trading statement can be saved, thus resulting in a prevention of loss of important data by co-operating with the route switching.

1. An information processing system in which an information terminal communicates with an information processor, in an external IP network, via a main circuit for normal use, or a secondary circuit for use when a failure occurs, each of which is provided with a router, wherein
the information terminal comprises a communication failure detecting means for detecting a communication failure at an application level during communication with the information processor, and a route switching instruction means for instructing the router to switch from a main circuit to a secondary circuit in accordance with the detection of the communication failure,
said router comprising a route switching means to switch a communication route, between the information terminal and the information processor from the main circuit to a communication route via the secondary circuit, in accordance with the route switching instructions issued due to the failure.

2. A system according to claim 1 in which
the communication failure detecting means monitors recovery from the communication failure,
the route switching instructing means instructs the router to perform a route switching from the secondary circuit to the main circuit,
the route switching means switches the communication route between the information terminal and the information processor from a route via the secondary circuit to a route via the main circuit, in accordance with the route switching instructions due to the recovery.

3. A system according to claim 1 in which the main circuit and the secondary circuit have different IP addresses and an external network through which the main circuit passes is different from an external network through which the secondary circuit passes.

4. A system according to claim 1 in which the main circuit is full-time connected and the secondary circuit is only used during a failure.

5. An information processing system in which an information terminal communicates with an information processor in an external IP network via a main circuit for normal use or a secondary circuit for use when a failure occurs, each of which is provided with a router, wherein
the information terminal comprises:
a communication failure detecting means for detecting a communication failure at an application level during communication with the information processor, and
a route switching instruction means for instructing the router to switch from a main circuit to a secondary circuit in accordance with the detection of the communication failure.

6. An information terminal according to claim 5 in which the communication failure is a disconnection of a communication session between a client application of the information terminal and a server application of the information processor.

7. An information processing system in which an information terminal communicates with an information processor in an external IP network via a main circuit for normal use or a secondary circuit for use when a failure occurs, provided with a router, wherein
the router has:
a receiving means for receiving route switching instructions based on a communication failure at an application level, supplied from the information terminal, and
a route switching means for switching the communication route between the information terminal and the information processor from the main circuit to a route via the secondary circuit.

8. A router according to claim 7, further comprising an environment configuration file containing line connection information for each of the main and secondary circuits, in which the route switching by the route switching means is carried out based on the environment configuration file.

9. A router according to claim 8 wherein the main circuit and/or the secondary circuit is a dial-up line, and the route switching means carries out a dial-up connection, when a route is switched, in accordance with line connection information in the environment configuration file.

10. A router according to claim 7 in which the router is comprised of:
a main circuit router to which the main circuit is connected and a secondary circuit router to which the secondary circuit is connected, and
the route switching means switches the route passing through the secondary circuit router after passing through the main circuit router based on the detection of a communication failure.
